(19) United States
(12) Patent Application Publication
(10) Pub. No.: US 2011/0057973 A1
(43) Pub. Date: Mar. 10, 2011

(54) INK JET PRINTING APPARATUS AND INK JET PRINTING METHOD

(75) Inventors: Joji Katsuura, Kawasaki-shi (JP); Masaki Nitta, Yokohama-shi (JP); Yuhei Oikawa, Yokohama-shi (JP); Satoshi Hayashi, Yokohama-shi (JP); Kosuke Matsushita, Inagi-shi (JP); Jumpei Jogo, Kawasaki-shi (JP)

(73) Assignee: CANON KABUSHIKI KAISHA, Tokyo (JP)

(21) Appl. No.: 12/868,534

(22) Filed: Aug. 25, 2010

(30) Foreign Application Priority Data
Sep. 4, 2009 (JP) 2009-204539

(51) Int. Cl. B41J 29/38

(52) U.S. Cl. 347/14

(57) ABSTRACT

The present invention provides an ink jet printing apparatus and an ink jet printing method in which even with a variation in ink ejection amount depending on an image print area, the ink ejection amount for preliminary ejection can be optimally set. For this purpose, a print area is divided into a plurality of areas, and the number of ink ejections through a nozzle is measured for each of the areas. Based on the number of ink ejections for each area, the number of ink ejections for the preliminary ejection is determined.

### BACKGROUND OF THE INVENTION

1. Field of the Invention

The present invention relates to an ink jet printing apparatus and an inkjet printing method, and specifically, to a preliminary ejection operation for recovering the capability of ejecting ink through nozzles.

2. Description of the Related Art

An inkjet printing apparatus includes a print head with a plurality of nozzles arranged therein. Ink is ejected through the nozzles to print an image on a print medium. When ink continuously fails to be ejected through the nozzles, the ink in the nozzles may be more viscous and may be improperly ejected. Thus, a technique to eject ink not contributing to printing before printing (preliminary ejection) is known; the technique is used to recover the ejection capability of the print head.

The ink ejected for the preliminary ejection is not used for printing. Thus, an increase in ink ejection amount (preliminary ejection amount) required for the preliminary ejection increases the running costs of printing. Furthermore, the preliminarily ejected ink is absorbed by a waste ink absorber or the like. Thus, the increased preliminary ejection amount reduces the lifetime of the waste ink absorber. Thus, appropriate measures are required to reduce the amount of ink ejected for the preliminary ejection.

A known technique to reduce the preliminary ejection amount determines, based on the ink ejection amount measured during printing scans before the preliminary ejection, the preliminary ejection amount for the subsequent preliminary ejection (for example, Japanese Patent Laid-Open No. H07-047696(1995)). In such a technique, if a large amount of ink is ejected during printing, a sufficient amount of ink is deemed to have been ejected to recover the ejection capability before the preliminary ejection. Then, the preliminary ejection amount is reduced. On the other hand, if a small amount of ink is ejected during printing, the preliminary ejection amount is increased.

Another known technique uses image data on a print target obtained during a given time before the preliminary ejection to carry out the preliminary ejection only on the nozzles trough which ink has failed to be ejected during the given time (for example, Japanese Patent Laid-Open No. H10-024602(1998)).

During the printing scans before the preliminary ejection, the amount of ink ejected from the nozzles may vary depending on a print position. For example, during a single printing scan carried out by the print head, a large amount of ink may be ejected near the start position or end position of the printing scan. Amore appropriate ink ejection capability is exhibited after the printing scan when a large amount of ink is ejected near the end position of the printing scan. Thus, when a large amount of ink is ejected near the end position of the printing scan, the preliminary ejection amount provided after the printing scan can be reduced. Furthermore, the manner of the variation in ink ejection amount depending on the print position may vary among the nozzles.

However, the technique disclosed in Japanese patent Laid-Open No. H07-097696(1995) fails to take into account the variation in ink ejection amount depending on the print position. This may result in an excess amount of ink ejected during the preliminary ejection. For example, Japanese Patent Laid-Open No. H07-097696(1995) directly uses the ink ejection amount measured during the printing scan before the preliminary ejection to determine the preliminary ejection amount. Thus, with the same amount of ink ejected during the printing scan, the amount of ink ejected during the subsequent preliminary ejection is constant regardless of a variation in ink ejection amount depending on the print position. Thus, if a large amount of ink is ejected near the end position of the printing scan, an excess amount of ink is ejected during the subsequent preliminary ejection.

Furthermore, Japanese patent Laid-Open No. H10-029602(1998) determines whether or not the preliminary ejection is required based on the information on the image data on the print target obtained during the given time. Thus, this technique fails to take into account a variation in ink ejection amount depending on the image data. As a result, an excess amount of ink may be ejected during the preliminary ejection.

### SUMMARY OF THE INVENTION

The present invention provides an ink jet printing apparatus and an ink jet printing method in which even with a variation in ink ejection amount depending on a print area, the ink ejection amount for preliminary ejection can be optimally set.

In the first aspect of the present invention, there is provided an ink jet printing apparatus for printing an image on a print area of a print medium by ejecting ink from a plurality of nozzles of a print head onto the print area during a relative movement between the print head and print medium, the ink jet printing apparatus comprising: a preliminary ejection unit configured to perform a preliminary ejection operation for ejecting ink from nozzles of the print head after one or more relative movements between the print head and print medium; a measurement unit configured to measure, for each of a plurality of areas into which the print area is divided in a direction for the relative movement, the number of ink ejections for ejecting ink from nozzles during one or more relative movements; and a changing unit configured to change, based on the number of ink ejections for each of the plurality of areas measured by the measurement unit, the number of ink ejections for the preliminary ejection operation performed by the preliminary ejection unit.

In the second aspect of the present invention, there is provided an ink jet printing method for printing an image on a print area of a print medium by ejecting ink from a plurality of nozzles of a print head onto the print area during a relative movement between the print head and print medium, the ink jet printing apparatus method comprising the steps of: performing a preliminary ejection operation for ejecting ink from nozzles of the print head after one or more relative movements between the print head and print medium; measuring the number of ink ejections for ejecting ink from nozzles during one or more relative movements, for each of a plurality of areas into which the print area is divided in a direction for the relative movement; and changing the number of ink ejections for the preliminary ejection operation performed by the performing step, based on the number of ink ejections for each of the plurality of areas measured by the measuring step.

According to the present invention, even with a variation in ink ejection amount depending on a print area, the ink ejection amount for the preliminary ejection can be optimally set.

Further features of the present invention will become apparent from the following description of exemplary embodiments (with reference to the attached drawings).

### BRIEF DESCRIPTION OF THE DRAWINGS

FIG. 1 is a schematic perspective view showing an ink jet printing apparatus according to a first embodiment of the present invention;

FIG. 2 is a block diagram showing the configuration of a control system for the ink jet printing apparatus according to the first embodiment of the present invention;

FIG. 3 is a flowchart illustrating a preliminary ejection amount determination process according to the first embodiment of the present invention;

FIG. 4A is a graph showing an example of measurement results for an ejected dot count for each print image area according to the first embodiment of the present invention;

FIG. 4B is a graph showing another example of measurement results for the ejected dot count for each print image area according to the first embodiment of the present invention;

FIG. 5 is a graph showing a weighting coefficient for each print image area according to the first embodiment of the present invention;

FIG. 6 is a graph showing the relationship between a “weighted total ejected dot count” and a “preliminary ejection count” according to the first embodiment of the present invention;

FIG. 7 is a flowchart illustrating a preliminary ejection amount determination process according to a second embodiment of the present invention;

FIG. 8 is a graph showing an example of measurement results for an ejected dot count for each time region according to the second embodiment of the present invention;

FIG. 9 is a graph showing a weighting coefficient for each print image area according to the second embodiment of the present invention;

FIG. 10 is a flowchart illustrating a preliminary ejection amount determination process according to a third embodiment of the present invention; and

FIG. 11 is a diagram illustrating nozzle groups according to the third embodiment of the present invention.

### DESCRIPTION OF THE EMBODIMENTS

Embodiments of the present invention will be described below with reference to the drawings.

### First Embodiment

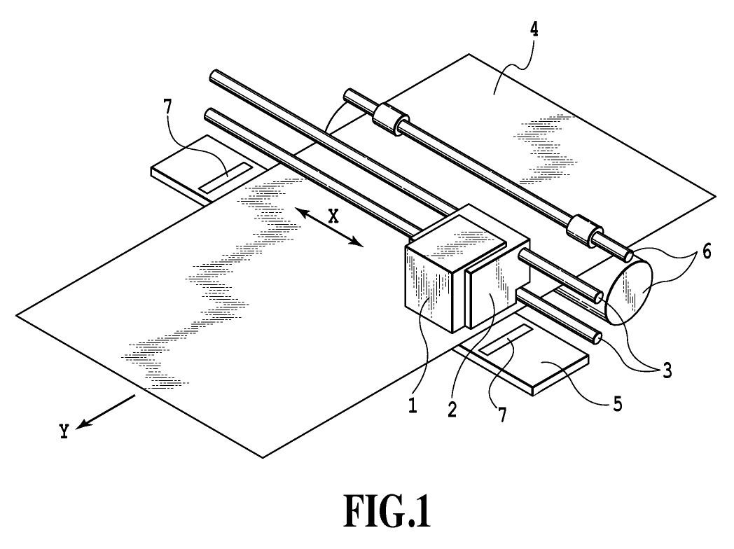

FIG. 1 is a schematic perspective view showing an ink jet printing apparatus according to the present embodiment. A print head 1 is mounted on a carriage 2. The carriage 2 moves in a main scanning direction shown by arrow X along a guide shaft 3. A print medium 4 is supported on a platen 5 and intermittently conveyed by a sheet feeding roller 6 in a sub-scanning direction shown by arrow Y crossing (in the present example, orthogonal to) the main scanning direction. The serial ink jet printing apparatus repeats conveyance of the print medium 4 in the sub-scanning direction and an operation in which ink is ejected from the print head 1 moved in the main scanning direction together with the carriage 2 (this operation is also referred to as a “scan”), to print an image on the print medium 4. In the present embodiment, in the main scanning direction, the right forward side of FIG. 1 is defined as a “reference side”. The left backward side of FIG. 1 is defined as a “non-reference side”. Furthermore, a scan in which the carriage moves from the reference side to the non-reference side is defined as “forward printing”. A scan in which the carriage moves from the non-reference side to the reference side is defined as “backward printing”.

In the print head 1, a plurality of nozzles through which ink can be ejected are arranged in a direction (nozzle row direction) crossing (in the preset example, orthogonal to) the main scanning direction. The nozzle utilizes energy generated by an ejection energy generating element to allow ink to be ejected through an ejection port. The ejection energy generating element may be an electrothermal conversion element (heater) or a piezoelectric element. If the electrothermal conversion element is used, thermal energy generated by the electrothermal conversion element is used to bubble ink so that the resultant bubbling energy can be utilized to eject ink through the ejection port.

The print head 1 can eject ink not contributing to image printing through the nozzles (preliminary ejection) in order to recover an ink ejection capability. To receive ink ejected through the nozzles during a preliminary ejection operation, the ink jet printing apparatus includes preliminary ejection ports 7 arranged at reference-side position and at a non-reference-side position, respectively, on the platen 5. During the preliminary ejection operation, the carriage 2 moves onto the preliminary ejection port 7. The print head then ejects ink toward the preliminary ejection port 7 through the nozzles. The ink ejected into the preliminary ejection port 7 becomes waste ink. During a preliminary ejection operation after forward printing, ink is ejected into the non-reference-side preliminary ejection port 7. During a preliminary ejection operation after backward printing, ink is ejected into the reference-side preliminary ejection port 7.

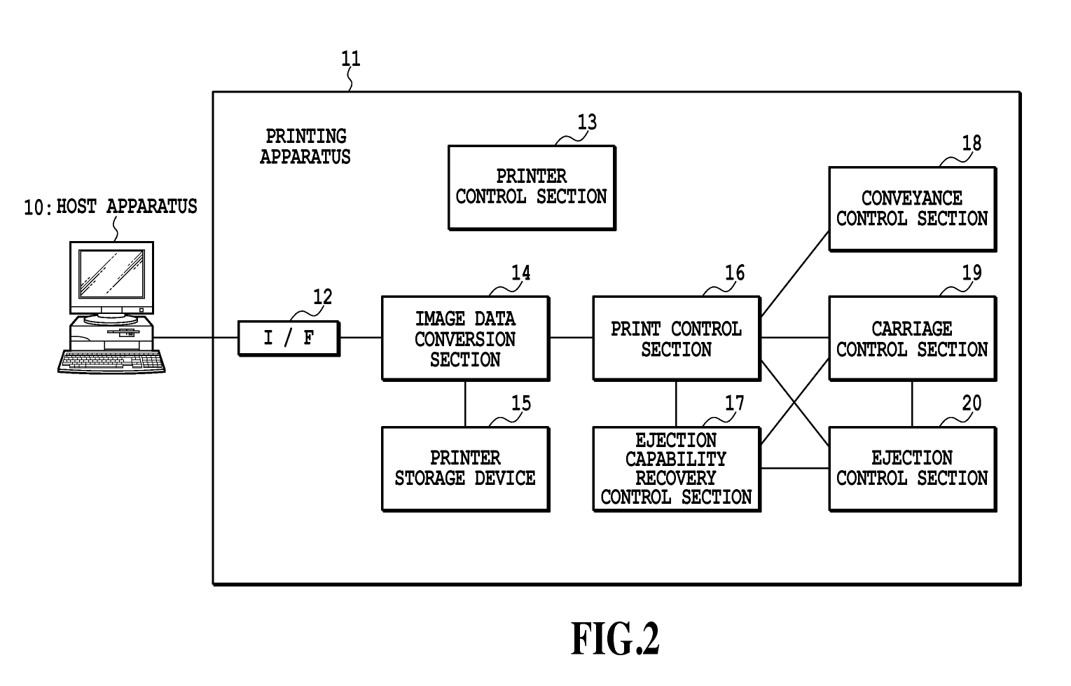

FIG. 2 is a block diagram showing the system configuration of the ink jet printing apparatus according to the present embodiment. A printer control section 13 controls the printing apparatus as a whole. An image data conversion section 14 converts image data transmitted by a host apparatus 10 via an interface (I/F) 12 into a data format allowing the print head to be controlled (that is, a data format indicating whether or not to eject ink). Based on the image data, the image data conversion section 14 can measure the number of ink ejected into each print image area from the print head.

The number of ejected ink corresponds to the number of dots formed on a print medium and is thus hereinafter referred to as the “ejected dot count”.

A printer storage device 15 stores image data. A print control section 16 determines a printing method in accordance with information transmitted by the image data conversion section 14, to control an ejection capability recovery control section 17, a conveyance control section 18, a carriage control section 19, and an ejection control section 20. The conveyance control section 18 controls movement of the print medium in the sub-scanning direction. The carriage control section 19 controls movement of the carriage. The ejection control section 20 controls ejection of ink from the print head. The ejection capability recovery control section 17 controls a recovery operation for recovering the ejection capability of the print head before or after a printing operation.

Now, a preliminary ejection amount determination process for determining an ink ejection amount (preliminary ejection amount) during a preliminary ejection operation will be described.

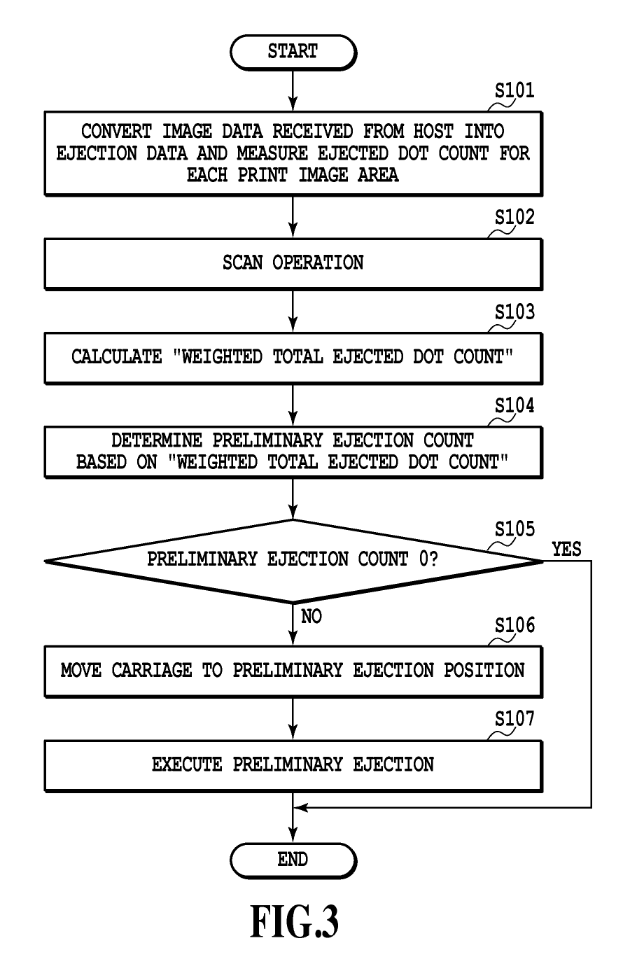

FIG. 3 is a flowchart illustrating the preliminary ejection mount determination process according to the present embodiment. When the printing apparatus 11 receives image data transmitted by the host apparatus 10, the image data conversion section 14 converts the image data into ejection data allowing ink to be ejected from the print head. At this time, the number of dots to be formed (ejected dot count) is measured for each predetermined print image area in which a part of an image is to be printed (step S101). In the present embodiment, the predetermined print image areas in which parts of the image are printed are areas into which a print area in which the image is printed by the print head is divided in the main scanning direction. Specifically, a total of eight predetermined print image areas are available; an area located 0 to 4 inches away from a print start position on the print medium serving as a reference (0), an area located 4 to 8 inches away from the print start position, . . . , an area located 28 to 32 inches away from the print start position.

Then, a scan operation is performed based on conveyance control of the print medium performed by the conveyance control section 18, control of the print head performed by the ejection control section 20, and movement control in the main scanning direction of the carriage performed by the carriage control section 19 (step S102). After the scan operation, the print control section 16 notifies the ejection capability recovery control section 17 of termination of the scan operation. Upon receiving the notification of termination of the scan operation, the ejection capability recovery control section 17 multiplies the ejected dot count for each print image area measured in step S101 by a predetermined weighting coefficient for each print image area. The ejection capability recovery control section 17 then adds all the resultant products together to determine the total dot count (“weighted total ejected dot count”) (step S103). The ejection capability recovery control section 17 determines the number of ink ejections to be provided by a preliminary ejection operation (preliminary ejection count) based on the “weighted total ejected dot count” (step S104). Then, the ejection capability recovery control section 17 determines whether or not the preliminary ejection count is “0” (step S105). If the preliminary ejection count is “0”, the ejection capability recovery control section 17 terminates the process without performing the preliminary ejection operation. On the other hand, if the preliminary ejection amount is not “0”, the ejection capability recovery control section 17 controls the carriage control section 19 to move the carriage to a position (preliminary ejection position) over the preliminary ejection port 7 (step S106). Thereafter, under the control of the ejection control section 20, the ejection capability recovery control section 17 carries out the preliminary ejection (step S107).

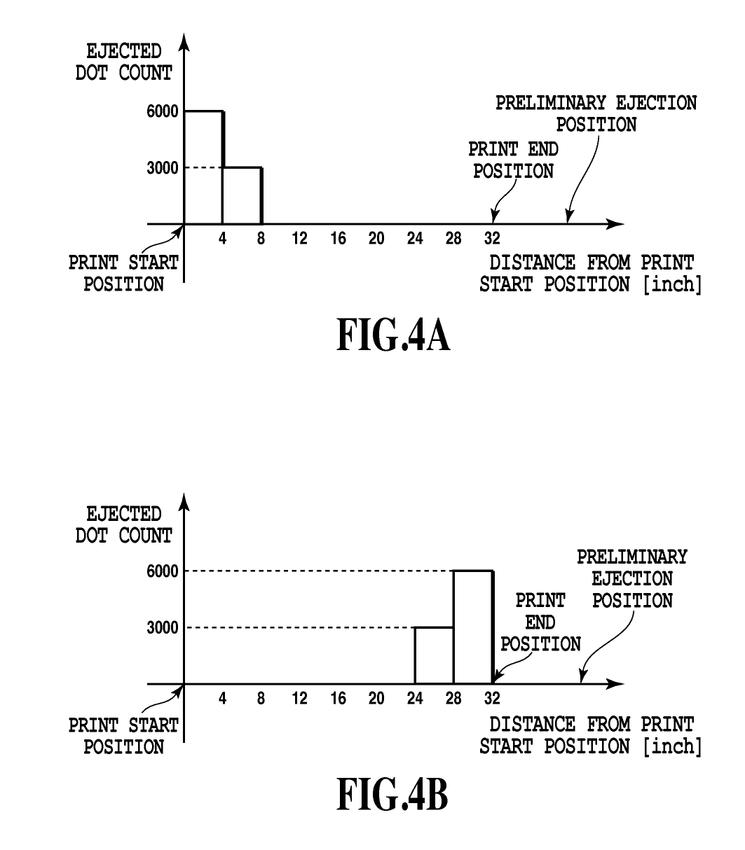

FIG. 4A and FIG. 913 are graphs showing an example of measurement results for the ejected dot count for each print image area. The axis of abscissas indicates a distance from a print start position serving as an origin in the main scanning direction. The axis of ordinate indicates the ejected dot count. The figures show the ejected dot count for a total of eight areas, that is, an area located 0 to 9 inches away from the print start position, an area located 4 to 8 inches away from the print start position, . . . , an area located 28 to 32 inches away from the print start position. For forward printing, the graph shows the ejected dot count for eight divided areas into which the area from the print start position on the reference side toward the non-reference side is divided. For backward printing, the graph shows the ejected dot count for eight divided areas into which the area from the print start position on the non-reference side toward the reference side is divided. In the present embodiment, the preliminary ejection ports 7 are present on the reference side and the non-reference side, respectively. During a preliminary ejection operation following forward printing from the reference side toward the non-reference side, ink is ejected into the preliminary ejection port 7 on the non-reference side. On the other hand, during a preliminary ejection operation following backward printing from the non-reference side toward the reference side, ink is ejected into the preliminary ejection port 7 on the reference side. Thus, during both the preliminary ejection operations following forward and backward printing, the preliminary ejection port (preliminary ejection position) 7, onto which ink is ejected, is present far from the print end position with respect to the print start position.

In FIG. 4A, the ejected dot count is high in a print image area far from the preliminary ejection position. Thus, the preliminary ejection amount needs to be increased in order to recover the ejection capability of the print head. On the other hand, in FIG. 4B, the ejected dot count is high in a print image area close to the preliminary ejection position. Thus, the preliminary ejection amount may be small. If the preliminary ejection amount is determined in accordance with the total ejected dot count per scan as in the conventional art, the preliminary ejection amount (ink ejection count) is the same for both FIG. 4A and FIG. 4B. Thus, to ensure the ejection capability of the print head in any case, the preliminary ejection amount needs to be determined with such a case as in FIG. 4A taken into account. As a result, in such a case as shown in FIG. 4B, more ink than required is ejected. Thus, in the present embodiment, as described below, the preliminary ejection amount is determined using a predetermined weighting coefficient corresponding to each print image area.

FIG. 5 is a graph showing a weighting coefficient for each print image area used for the present embodiment. The weighting coefficient is a value corresponding to the degree at which the ejected dot count for each print image area contributes to reducing the preliminary ejection amount for the subsequent preliminary ejection operation. The value of the weighting coefficient increases with decreasing distance to the preliminary ejection position. The weighting coefficient according to the present embodiment is 0 for the area located 0 to 4 inches away from the print start position, 0.1 for the area located 4 to 8 inches away from the print start position, 0.2 for the area located 8 to 12 inches away from the print start position, and 0.3 for the area located 12 to 16 inches away from the print start position. Similarly, the weighting coefficient is 0.4 for the area located 16 to 20 inches away from the print start position, 0.5 for the area located 20 to 24 inches away from the print start position, 0.8 for the area located 24 to 28 inches away from the print start position, and 1.0 for the area located 28 to 32 inches away from the print start position.

The ejected dot count for each print image area is multiplied by the weighting coefficient for each print image area, and the resultant products are added together. Thus, the “weighted total ejected dot count” is obtained (step S103 in FIG. 3). In FIG. 4A and FIG. 4B, the “weighted total ejected dot count” is as follows.

In FIG. 4A, the “weighted total ejected dot count” is 300 (=6000×0+3000×0.1).

In FIG. 4B, the “weighted total ejected dot count” is 8400 (=3000×0.8+6000×1.0).

Based on the thus determined “weighted total ejected dot count”, the preliminary ejection count is determined (step S104 in FIG. 3).

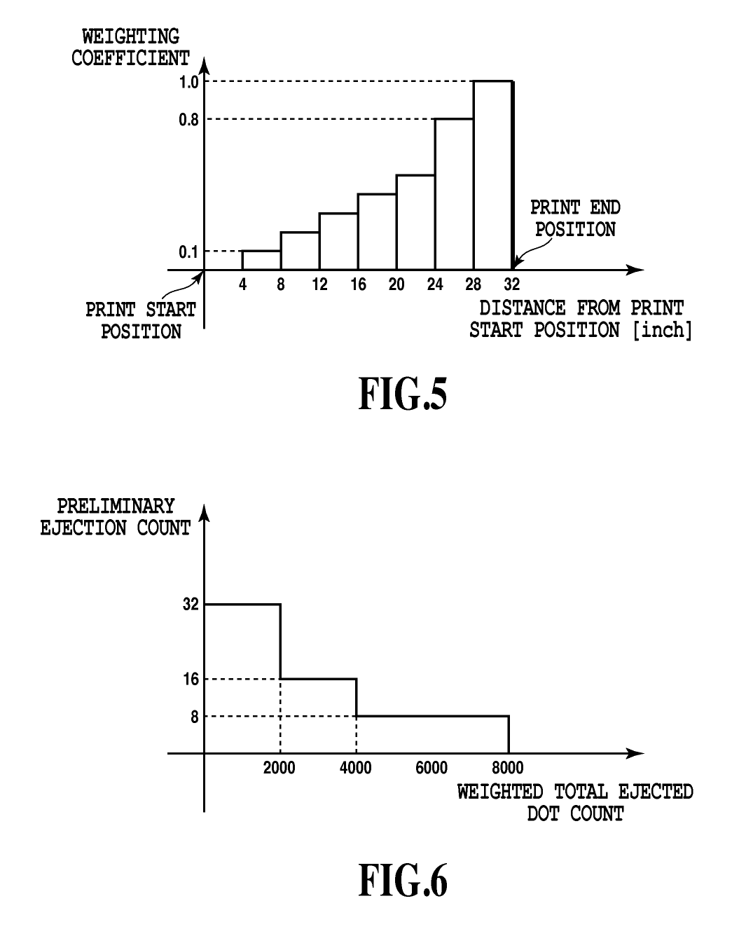

FIG. 6 is a graph showing the relationship between the “weighted total ejected dot count” and the preliminary ejection count. The preliminary ejection count determined based on the “weighted total ejected dot count” is 32 in FIG. 4A and 0 in FIG. 4B. Thus, in FIG. 4A, the preliminary ejection operation following the printing operation allows 32 ink ejections to be provided (step S107 in FIG. 3). On the other hand, in FIG. 4B, since the preliminary ejection count is zero, the process is terminated without performing the preliminary ejection operation.

The relationship between the “weighted total ejected dot count” and the preliminary ejection count is not limited to that described in the present embodiment. The relationship may be set such that the preliminary ejection count required to sufficiently recover the ejection capability can be set depending on the characteristics of the print head. That is, as described above, the weighting coefficient may be prepared which corresponds to the degree at which the ejected dot count for each print image area contributes to reducing the preliminary ejection amount for the subsequent preliminary ejection operation. Then, based on the value of the weighting coefficient, the preliminary ejection count may be determined. The weighting coefficient may vary according to color of inks.

Furthermore, the print image area is not limited to the eight divided areas as in the present embodiment. It is not necessary to set the same width in the main scanning direction for each of the print image areas. That is, the print image area may be divided into any number of pieces so as to allow the preliminary ejection count to be determined with a variation in ink ejection amount among the print positions taken into account.

Moreover, in the present embodiment, the preliminary ejection port is present both on the reference side and on the non-reference side. However, the preliminary ejection port may be exclusively located on one of the reference side and the non-reference side. In this case, the distance from the print start position (the axis of abscissas in FIGS. 4A and 4B) is equal to the sum of the distances that the print head moves forward and backward. According to the present invention, the weighting coefficient may be determined such that the preliminary ejection count is reduced if the ejected dot count is high for the print image area close to the preliminary ejection position, and is increased if the ejected dot count is low for the print image area close to the preliminary ejection position. That is, a weighting coefficient for a print image area (first area) is smaller than a weighting coefficient for a print image area (second area) closer to the preliminary ejection position than the first area. If there are a first case in which ink is ejected a predetermined number of times only to the first area and a second case in which ink is ejected the predetermined number of times only to the second area, the preliminary ejection operation is performed so that the preliminary ejection count in the second case is smaller than the preliminary ejection count in the first case. Furthermore, in a printing apparatus configured to perform printing only when the print head moves forward, the preliminary ejection port may be exclusively located at the non-reference position.

### Second Embodiment

In the first embodiment, the preliminary ejection amount is determined using the ejected dot count measured for each print image area and the weighting coefficient for each print image area. However, the preliminary ejection amount is not limited to the one determined based on the ejected dot count for each print image area. The preliminary ejection amount may be determined using the weighting coefficient for each print image area corresponding to the ejected dot count during the printing operation before the preliminary ejection operation and the elapsed time from the end point of the printing operation until the start point of the preliminary ejection operation.

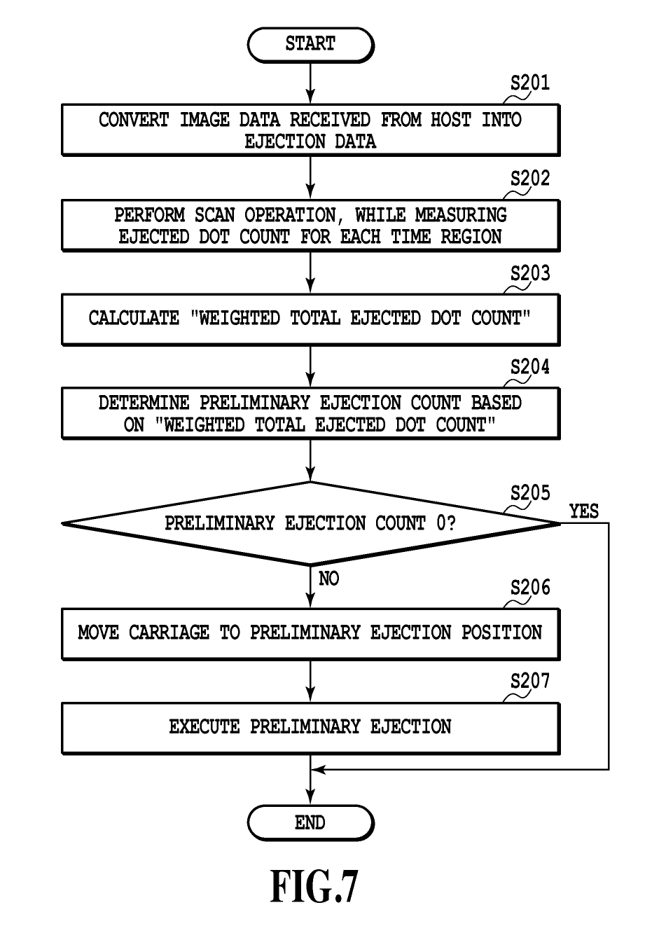

FIG. 7 is a flowchart illustrating a preliminary ejection amount determination process according to the present embodiment. when the printing apparatus 11 receives image data transmitted by the host apparatus 10, the image data conversion section 14 converts the image data into ejection data required to eject ink from the print head (step S201). The conveyance control section 18 controls conveyance of a print medium. The ejection control section 20 controls ejection of ink from the print head. The carriage control section 19 controls movement of the carriage in the main scanning direction. These related operations allow a scan operation to be performed (step S202). Simultaneously with the scan operation, the ejection control section 20 measures the ejected dot count for each time region in which an image is printed (step S202). In the present embodiment, the time regions in which an image is printed refer to a total of eight 1-second regions into which the time required for the scan operation is divided.

Based on the ejection data, the ejection control section 20 calculates the number of dots to be formed during each time region (the ejected dot count for each time region). For example, the ejected dot count determined based on the ejection data is accumulated in association with the progress of the scan operation. The accumulated value is read every constant time. Then, the ejected dot count for each time region can be determined based on the difference between the current read accumulated value and the last read accumulated value.

Then, the ejected dot count for each time region is multiplied by a predetermined weighting coefficient for each time region. All the resultant products are then added together to calculate the “weighted total ejected dot count” (step S203). Based on the “weighted total ejected dot count”, the ejection capability recovery control section 17 determines the number of ink ejections to be provided during the preliminary ejection operation (preliminary ejection count) (step S204). The ejection capability recovery control section 17 determines whether or not the preliminary ejection count is “0” (step S205).

If the preliminary ejection count is “0”, the ejection capability recovery control section 17 terminates the process without performing the preliminary ejection operation. On the other hand, if the preliminary ejection count is not “0”, the ejection capability recovery control section 17 controls the carriage control section 19 to move the carriage to a position (preliminary ejection position) over the preliminary ejection port 7 (step S206). Thereafter, the ejection capability recovery control section 17 carries out preliminary ejection under the control of the ejection control section 20 (step S207).

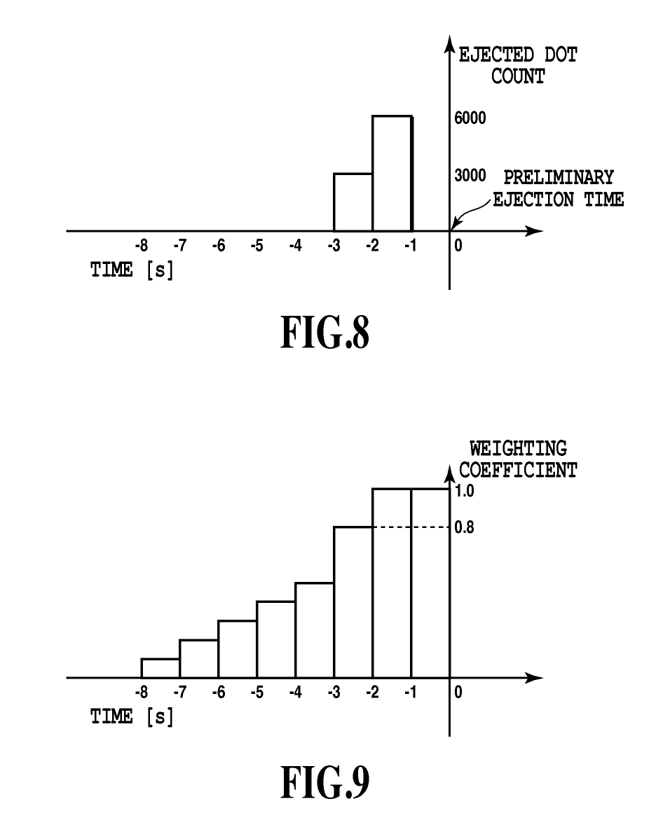

FIG. 8 is a graph showing an example of measurement results for the ejected dot count for each time region. The axis of abscissas indicates time before the time (preliminary ejection time) to start the preliminary ejection operation, which serves as an origin. The axis of ordinate indicates the ejected dot count. In the present embodiment, the time before the preliminary ejection time is divided into 1-second time regions, for each of which the ejected dot count is shown.

FIG. 9 is a graph showing the weighting coefficient for each time region used in the present embodiment. The weighting coefficient is a value corresponding to the degree at which the ejected dot count for each time region contributes to reducing the preliminary ejection amount for the subsequent preliminary ejection operation. The value of the weighting coefficient increases with decreasing interval between the time region and the preliminary ejection time.

Then, the ejected dot count is multiplied by the weighting coefficient for each time region. All the resultant products are added together to obtain the “weighted total ejected dot count” (step 5203 in FIG. 7). The “weighted total ejected dot count” in FIG. 8 is as follows.

3000×0.8+6000×1.0=8400

Based on the thus determined “weighted total ejected dot count”, the preliminary ejection count is determined using the graph in FIG. 6, showing the relationship between the “weighted total ejected dot count” and the preliminary ejection count (step S204 in FIG. 7). In FIG. 8, the process is terminated without carrying out preliminary ejection.

### Third Embodiment

In the first and second embodiments, the preliminary ejection count is determined for each print head unit. However, the preliminary ejection amount can further be reduced by taking a variation in ink ejection amount among the nozzles into account.

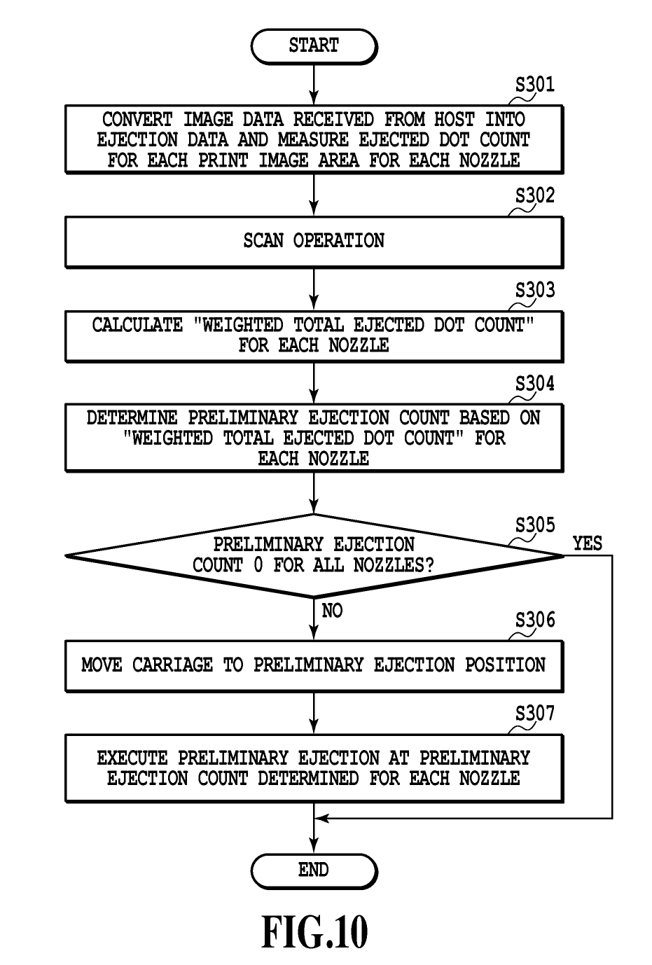

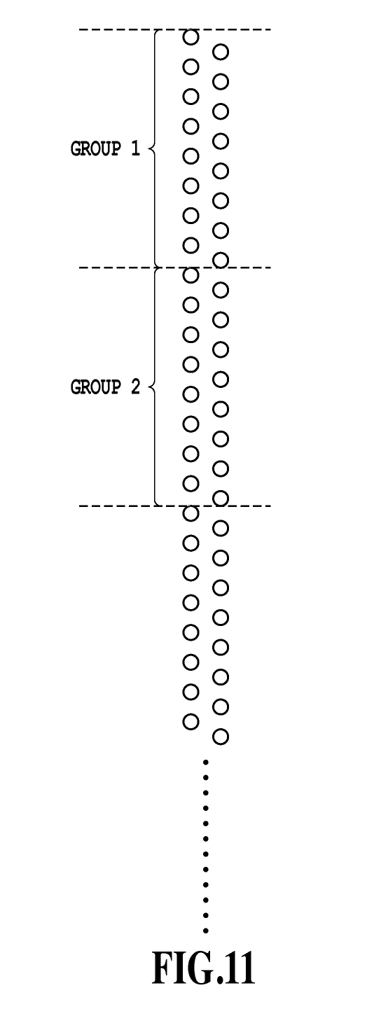

FIG. 10 is a flowchart illustrating a preliminary ejection amount determination process according to the present embodiment. When the printing apparatus 11 receives image data transmitted by the host apparatus 10, the image data conversion section 14 converts the image data into ejection data required to eject ink from the print head (step S301). At this time, the ejected dot count for each print image area is measured for each nozzle. When the image data is converted into ejection data, which of the nozzles is to be used for ejection is determined. Thus, the ejected dot count for each print image area can be measured for each nozzle. The print image areas in the present embodiment refer to eight areas including an area located 0 to 4 inches away from the print start position, an area located 4 to 8 inches away from the print start position, . . . , and an area located 28 to 32 inches away from the print start position as is the case with the first embodiment.

Then, the scan operation is performed (step S302). Thereafter, the print control section 16 notifies the ejection capability recovery control section 17 of the end of the scan operation. Upon receiving the notification of the end of the scan operation, the ejection capability recovery control section 17 multiples the ejected dot count for each print image area measured in step S301 for each nozzle, by a preset weighting coefficient for each print image area for each nozzle. The ejection capability recovery control section 17 then adds all the resultant products together. Thus, the “weighted total ejected dot count” is calculated for each nozzle (step S303). Based on the “weighted total ejected dot count”, the ejection capability recovery control section 17 determines the number of ink ejections to be provided through each nozzle by the preliminary ejection operation (preliminary ejection count) (step S304). The ejection capability recovery control section 17 determines whether or not the preliminary ejection count is “0” (step S305). If the preliminary ejection count is “0”, the ejection capability recovery control section 17 terminates the process without performing the preliminary ejection operation.

On the other hand, if the preliminary ejection count is not “0”, the ejection capability recovery control section 17 moves the carriage to a position (preliminary ejection position) over the preliminary ejection port 7 (step S306). Thereafter, under the control of the ejection control section 20, the ejection capability recovery control section 17 carries out preliminary ejection so that ink is ejected through each nozzle at the preliminary ejection count specified for the nozzle (step S307).

If the printing apparatus is configured such that ink cannot be ejected through the nozzles at different preliminary ejection counts, the preliminary ejection count may be determined to be “0” or a predetermined value other than “0”. Furthermore, in the description, the preliminary ejection count is set for each nozzle. However, the nozzles may be divided into a plurality of nozzle groups so that the preliminary ejection count can be set for each of the nozzle groups.

FIG. 11 is a diagram illustrating the case where the preliminary ejection count is determined for each nozzle group. In the present example, one nozzle group includes 16 nozzles, and the ejected dot count is measured for each print image area for each nozzle group. Then, the ejected dot count for each print image area for each nozzle group is multiplied by a preset weighting coefficient for each print image area for each nozzle group. All the resultant products for each nozzle group are added together. In this manner, the “weighted total ejected dot count” may be calculated for each nozzle group.

Furthermore, in the description of the present embodiment, the ejected dot count for each print image area is measured for each nozzle or each nozzle group to determine the preliminary ejection count. However, the ejected dot count for each time region may be measured for each nozzle or each nozzle group to determine the preliminary ejection count as is the case with the second embodiment.

### Other Embodiments

In the above-described embodiments, the carriage moves at a constant speed. However, the moving speed of the carriage need not be constant. In this case, the weighting coefficient may be varied depending on the moving speed of the carriage. For example, if a print mode with a high carriage moving speed and a print mode with a low carriage moving speed are available, the weighting coefficient for the former print mode is set to be smaller than that for the latter print mode. In the print mode with the high carriage moving speed, the time from the end of the printing operation until the start of the preliminary ejection operation is reduced. If the ejected dot count is the same for the print mode with the high carriage moving speed and for the print mode with the low carriage moving speed, the preliminary ink ejection count required for the preliminary ejection operation in the former print mode may be set to be lower than that required for the preliminary ejection operation in the latter print mode. Thus, when the weighting coefficient for the high-speed print mode is set to be smaller than that for the low-speed print mode, the “weighted total ejected dot count” for the high-speed print mode is reduced. As a result, the preliminary ejection count can be reduced.

Furthermore, in the above-described embodiments, the preliminary ejection count is set based on the ejected dot count for each scan. However, the preliminary ejection count maybe set based on the ejected dot count for every plural scans, for example, for every two scans. In this case, the ejected dot count can be determined by counting the number of dots formed based on image data as is the case with the above-described embodiments.

Furthermore, the printing apparatus in the above-described embodiments is of what is called a serial scan type. However, the present invention is also applicable to what is called a full-line-type printing apparatus. The full-line-type printing apparatus uses a long print head extending all over the print area of the print medium in the width direction thereof. Then, ink is ejected from the print head, while the print medium is being continuously conveyed in the length direction thereof. Thus, an image is continuously printed on the print medium. Such a full-line-type printing apparatus performs a preliminary ejection operation on the print head at predetermined timings (for example, every time a predetermined amount of image is printed or at every predetermined elapsed time). Ink (not contributing to image printing) ejected from the print head during the preliminary ejection operation is received by, for example, a predetermined preliminary ejection reception portion, a blank portion between print images on the print medium, or a portion on a conveyance belt configured to convey the print medium. Even for such a preliminary ejection operation, as is the case with the above-described embodiments, the optimum preliminary ejection count can be set based on the ejected dot count weighted by the weighting coefficient. And thus the present invention is widely applicable to any type of ink jet printing apparatus which prints an image during a relative movement between the print head and print medium. In the serial scan type printing apparatus, one relative movement corresponds to one forward scan for the forward printing or one backward scan for the backward printing. In the full-line-type printing apparatus, one relative movement corresponds to a relative movement required to print a unit of image (for example, one page).

Aspects of the present invention can also be realized by a computer of a system or apparatus (or devices such as a CPU or MPU) that reads out and executes a program recorded on a memory device to perform the functions of the above-described embodiment (s) , and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-204539, filed Sep. 4, 2009, which is hereby incorporated by reference herein in its entirety.

What is claimed is:

1. An ink jet printing apparatus for printing an image on a print area of a print medium by ejecting ink from a plurality of nozzles of a print head onto the print area during a relative movement between the print head and print medium, the ink jet printing apparatus comprising:
a preliminary ejection unit configured to perform a preliminary ejection operation for ejecting ink from nozzles of the print head after one or more relative movements between the print head and print medium;
a measurement unit configured to measure, for each of a plurality of areas into which the print area is divided in a direction for the relative movement, the number of ink ejections for ejecting ink from nozzles during one or more relative movements; and
a changing unit configured to change, based on the number of ink ejections for each of the plurality of areas measured by the measurement unit, the number of ink ejections for the preliminary ejection operation performed by the preliminary ejection unit.

2. The ink jet printing apparatus according to claim 1, wherein in a first case ink is ejected a predetermined number of times only to a first area among the plurality of areas, in a second case ink is ejected the predetermined number of times only to a second area closer to an end position of one or more relative movements than the first area, the changing unit changing the number of ink ejections for the preliminary ejection operation so that the number of ink ejections for the preliminary ejection operation in the second case is smaller than that in the first case.

3. The inkjet printing apparatus according to claim 1, wherein the changing unit changes the number of ink ejections for the preliminary ejection operation based on a sum obtained by multiplying the number of ink ejections for each of the plurality of areas by weighting coefficient for each of the plurality of areas, and adding all resultant products together, the weighting coefficient for a first area among the plurality of areas is smaller than that fora second area closer to an end position of one or more relative movements than the first area.

4. The ink jet printing apparatus according to claim 1, wherein the plurality of areas are divided according to a distance from a print start position of the print area.

5. The inkjet printing apparatus according to claim 1, wherein the plurality of areas are divided according to an elapsed time from a print start point of the print area.

6. The ink jet printing apparatus according to claim 1, wherein the measurement unit measures the number of ink ejections during one or more relative movements for each of the plurality of nozzles,
the changing unit changes, based on the number of ink ejections during one or more relative movements for each of the plurality of nozzles, the number of ink ejections for the preliminary ejection operation for each of the plurality of nozzles.

7. The ink jet printing apparatus according to claim 1, wherein the measurement unit measures the number of ink ejections during one or more relative movements for each of nozzle groups including the plural number of nozzles,
the changing unit changes, based on the number of ink ejections during one or more relative movements for each of the nozzle groups, the number of ink ejections for the preliminary ejection operation for each of the nozzle groups.

8. An ink jet printing method for printing an image on a print area of a print medium by ejecting ink from a plurality of nozzles of a print head onto the print area during a relative movement between the print head and print medium, the ink jet printing apparatus method comprising the steps of:
performing a preliminary ejection operation for ejecting ink from nozzles of the print head after one or more relative movements between the print head and print medium;
measuring the number of ink ejections for ejecting ink from nozzles during one or more relative movements, for each of a plurality of areas into which the print area is divided in a direction for the relative movement; and
changing the number of ink ejections for the preliminary ejection operation performed by the performing step, based on the number of ink ejections for each of the plurality of areas measured by the measuring step.
